(19) United States
(12) Patent Application Publication
(10) Pub. No.: US 2021/0284804 A1
(43) Pub. Date: Sep. 16, 2021

(54) SILOXANES HAVING BIS-(2-CYANOETHYL)AMINO-GROUPS

(71) Applicant: WACKER CHEMIE AG, Munich (DE)

(72) Inventor: Michael STEPP, Ueberackern (DE)

(73) Assignee: WACKER CHEMIE AG, Munich (DE)

(21) Appl. No.: 16/336,620

(22) PCT Filed: Sep. 26, 2016
(86) PCT No.: PCT/EP2016/072874

§ 371 Date: Mar. 26, 2019

(51) Int. Cl. C08G 77/26; C08G 77/392; C08G 77/388

(52) U.S. Cl. CPC C08G 77/26; C08G 77/388; C08G 77/392

(57) ABSTRACT

Siloxanes bearing radicals of the formula

-A-NR¹₂₋ₘ(CR²₂—CR³₂—CN)ₘ (2),

are able to absorb SO₂ and then safely desorb SO₂ while minimizing thermal runaway conditions.

### CROSS REFERENCE TO RELATED APPLICATIONS

This application is the U.S. National Phase of PCT Appln. No. PCT/EP2016/072874 filed Sep. 26, 2016, the disclosure of which is incorporated in its entirety by reference herein.

### BACKGROUND OF THE INVENTION

### 1. Field of the Invention

The invention relates to siloxanes having bis(2-cyanoethyl)amino groups, a process for crosslinking the siloxanes to form vulcanizates, the vulcanizates and a process for the reversible bonding of sulfur dioxide to the siloxanes and vulcanizates.

### 2. Description of the Related Art

The absorption of sulfur dioxide for purifying flue gases from refineries or from combustion processes, for example from power stations, is of major importance for the environment but is also of economic relevance. In this case, differentiation is made between non-regenerative processes (e.g. by lime scrubbing forming gypsum from FGD plants) and regenerative processes (e.g. the Wellman-Lord process), in which the bound SO₂ can be released again specifically for further use, for example for sulfur recovery. The regenerative processes are divided into processes in which chemical reactions result in assimilation of SO₂ and physical processes.

The latter have the advantage that they are usually fully reversible and the absorber often does not have to be renewed. For example, Kim, H. S. et al. Proceedings of the World Congress on Civil, Structural and Environmental Engineering, Prague, Mar. 30-31, 2016 (see also KR101495876, KIST, 2013) describe the advantages of nitrile-functional tertiary amines, N-methyl-N,N-dipropionitrile for example, which can reversibly bind up to 2 mol of SO₂ per mole of amine. In contrast to the ethanolamines typically used, they do not involve chemical reactions such that SO₂ desorption at 80° C. is fully reversible.

Investigations of the thermal stability have shown, however, that absorbents loaded with SO₂ already decompose thermally from ca. 160° C. This process is highly exothermic such that the 100 K rule in accordance with TRAS [Technical Regulation for Operational Safety] 410 at the required desorption temperature of at least 80° C. is not met.

### SUMMARY OF THE INVENTION

The invention provides siloxanes of the general formula 1

RₙSiO_{(4-n)/2} (1),

where
R is a hydrocarbon radical having 1-16 carbon atoms, which may be substituted by halogen, alkoxy, acyloxy, oximo, acryloxy or methacryloxy radicals, an OH radical, C₁-C₄-alkoxy radical, oximo radical of the general formula —O═NR⁵R⁶, amino radical of the general formula —NR⁷R⁸ or a radical of the general formula 2

-A-NR¹₂₋ₘ(CR²₂—CR³₂—CN)ₘ (2),
R¹ is hydrogen or a hydrocarbon radical having 1-6 carbon atoms or —C(O)—R′,
A is a bifunctional hydrocarbon radical having 1-18 carbon atoms, which may be interrupted by one or more non-adjacent heteroatoms selected from O, S and NR⁴,
R⁴ is hydrogen or a hydrocarbon radical having 1-6 carbon atoms or a radical CR^{2′}₂—CR^{3′}₂—CN or a radical —C(O)—R″,
R′, R², R³, R^{2′}, R^{3′} and R″ are hydrogen or hydrocarbon radicals having 1-6 carbon atoms,
R⁵, R⁶, R⁷ and R⁸ are methyl, ethyl, n-propyl or isopropyl radicals,
m has the values 0, 1 or 2 and
n has the average value 2.00-2.66,
with the proviso that
   at least 50 mol % of all R radicals are alkyl radicals,
   at least 0.5 mol % of all R radicals are a radical of the general formula 2 in which m has the values 1 or 2,
   at least 5 mol % of all radicals are of the general formula 2 in which m has the value 2,
   at most 10 mol % of all R¹ radicals are a hydrocarbon radical and
   at least 3 and at most 2000 Si atoms are present per molecule. The invention further pertains to the use of the siloxanes of formula 1 to reversibly absorb SO₂.

### DETAILED DESCRIPTION OF THE PREFERRED EMBODIMENTS

The invention provides siloxanes of the general formula 1

RₙSiO_{(4-n)/2} (1),

where
R is a hydrocarbon radical having 1-16 carbon atoms, which may be substituted by halogen, alkoxy, acyloxy, oximo, acryloxy or methacryloxy radicals, an OH radical, C₁-C₄-alkoxy radical, oximo radical of the general formula —O═NR⁵R⁶, amino radical of the general formula —NR⁷R⁸ or a radical of the general formula 2

-A-NR¹₂₋ₘ(CR²₂—CR³₂—CN)ₘ (2),
R¹ is hydrogen or a hydrocarbon radical having 1-6 carbon atoms or —C(O)—R′,
A is a bifunctional hydrocarbon radical having 1-18 carbon atoms, which may be interrupted by one or more non-adjacent heteroatoms selected from O, S and NR⁴,
R⁴ is hydrogen or a hydrocarbon radical having 1-6 carbon atoms or a radical CR^{2′}₂—CR^{3′}₂—CN or a radical —C(O)—R″,
R¹, R², R³, R^{2′}, R^{3′} and R″ are hydrogen or hydrocarbon radicals having 1-6 carbon atoms,
R⁵, R⁶, R⁷ and R⁸ are methyl, ethyl, n-propyl or isopropyl radicals,
m has the values 0, 1 or 2 and
n has the average value 2.00-2.66,
with the proviso that
   at least 50 mol % of all R radicals are alkyl radicals,
   at least 0.5 mol % of all R radicals are a radical of the general formula 2 in which m has the values 1 or 2,
   in at least 5 mol% of all radicals are of the general formula 2, m has the value 2,
   at most 10 mol % of all R¹ radicals are a hydrogen radical and
   at least 3 and at most 2000 Si atoms are present per molecule.

In the state of SO₂ loading, the siloxanes according to the invention of the general formula 1 having bis(2-cyanoethyl)aminoalkyl units are significantly more stable than the known nitrile-functional tertiary amines, but exhibit analogous absorption characteristics. The desorption can thus be carried out at a distinctly higher temperature and thereby be accelerated. This thermal behavior was not predictable.

The siloxanes of the general formula 1 are preferably linear, cyclic or branched. They are oligosiloxanes or polysiloxanes.

Examples of C₁-C₁₆-hydrocarbon radicals R are alkyl radicals such as the methyl, ethyl, n-propyl, isopropyl, n-butyl, 2-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical; cycloalkyl radicals such as cyclopentyl, cyclohexyl, 4-ethylcyclohexyl, cycloheptyl radicals, norbornyl radicals and methylcyclohexyl radicals or else alkenyl radicals such as the vinyl, 2-propen-2-yl, allyl, 3-buten-1-yl, 5-hexen-1-yl, 10-undecen-1-yl radicals, cycloalkenyl radicals such as the 2-cyclohexenyl, 3-cyclohexenyl, cyclopentadienyl radical, and 2-(cyclohex-3-en-1-yl)ethyl radicals, aryl radicals such as the phenyl, biphenylyl, and naphthyl radicals; alkaryl radicals such as o-, m-, p-tolyl radicals and phenethyl radicals (2-phenylethyl, 1-phenylethyl radical) and aralkyl radicals such as the benzyl radical.

Examples of substituted hydrocarbon radicals are halogenated hydrocarbons such as the 3,3,3-trifluoropropyl and 5,5,5,4,4,3,3-heptafluoropentyl radical. R preferably comprises 1-6 carbon atoms, more preferably 1-4 carbon atoms. R is most preferably the methyl radical. Among the unsaturated radicals, preference is given to the vinyl radical.

The halogen radicals on R are preferably chlorine, fluorine or bromine.

The alkoxy radicals on R preferably comprise 1-6 carbon atoms and are particularly selected from ethyl and methyl radicals.

Examples of the hydrocarbon radicals R¹, R′, R², R³, R⁴, R^{2′}, R^{3′} and R″ having 1-6 carbon atoms are listed in the examples for R. Preferred hydrocarbon radicals are in each case ethyl and methyl radicals.

Preferred as R¹ are hydrogen and CH₃—CO—.

Preferred as R², R³ is hydrogen in each case.

A is preferably a bifunctional hydrocarbon radical having 1-8 carbon atoms, which may be interrupted by one or more non-adjacent heteroatoms selected from O and NR⁴. Preferred radicals A are
—CH₂—CH₂—CH₂—, —CH₂—CH₂—CH₂—N (—CH₂—CH₂—CN)—CH₂—CH₂—, —CH₂—CH₂—CH₂—N (—COCH₃)—CH₂—CH₂—, —CH₂—CH₂—CH₂—NH—CH₂—CH₂—.

The radicals R⁵, R⁶, R⁷ and R⁸ are preferably methyl or ethyl radicals.

In a preferred embodiment, 1 to 75 mol %, especially 3 to 20 mol % of the R radicals are selected from the radicals OH, C₁-C₄-alkoxy, oximo radicals of the general formula —O═NR⁵R⁶, and amino radicals of the general formula —NR⁷R⁸.

The radicals OH, C₁-C₄-alkoxy, oximo radicals of the general formula —O═NR⁵R⁶, and amino radicals of the general formula —NR⁷R⁸ are bonded directly to the silicon atom.

Preferably, m has a value of 2 in at least 20 mol %, especially in at least 50 mol % of all radicals of the general formula 2.

n preferably has the average value 2.01-2.4.

Preferably, at most 80 mol %, especially at most 95 mol % of all R radicals are an alkyl radical.

Preferably, at least 1 mol %, especially at least 5 mol % of all R radicals are a radical of the general formula 2, in which m has the values 1 or 2.

Preferably, at most 10 mol % of all R¹ radicals are a hydrogen radical.

Preferably, at least 30 and at most 600 Si atoms are present per molecule of the general formula 1.

The siloxanes of the general formula 1 are prepared preferably by aza-Michael addition of acrylonitrile to primary or secondary amine functions of aminofunctional (poly)siloxanes, such as already described by Baselga, J. et al. in Polymer 69, 178-185 (2015).

Siloxanes of the general formula 1, comprising Si-bonded radicals selected from OH, C₁-C₄-alkoxy, oximo radicals of the general formula —O═NR⁵R⁶, and amino radicals of the general formula —NR⁷R⁸, are preferably prepared by reacting silanol-containing siloxanes of the general formula 1 with silanes comprising tri- or tetrafunctional amino, alkoxy or oximo groups or partial hydrolyzates thereof, optionally in the presence of a condensation catalyst such as, e.g., dibutyltin oxide, dibutyltin dilaurate, tetraisopropyl titanate, tetra-n-butyl titanate, aluminum tri-sec-butylate, tetra-n-butylammonium fluoride, tetra-n-butylammonium hydroxide, lithium hydroxide. Examples of such silanes are: Si(OEt)₄, Si(O—N═CMeEt)₄, Si(NEt₂)₄, (EtO)₃Si—O—Si(OEt)₃, Me—Si(OEt)₃, Me—Si(OMe)₃, vinyl-Si(OMe)₃, vinyl-Si(OEt)₃, phenyl-Si(OEt)₃, phenyl-Si(OMe)₃, Me—Si(O—N═CEtMe)₃, Me—Si(NEt₂)₃, O(CH₂CH₂)₂N—CH₂—Si(OEt)₃, phenyl-NH—CH₂—Si(OMe)₃, (H₃CCH₂CH₂CH₂)₂N—CH₂—Si(OEt)₃, H₂N—(CH₂)₃—Si(OMe)₃, H₂N—(CH₂)₃—Si(OEt)₃, H₂N—(CH₂)₂—NH—(CH₂)₃—Si(OMe)₃, cyclohexyl-NH—(CH₂)₃—Si(OMe)₃, cyclohexyl-NH—(CH₂)₃—Si(OEt)₃, H₂C═CH—COO—(CH₂)₃—Si(OEt)₃, H₂C═CH—COO—(CH₂)₃—Si(OMe)₃, H₂C═CH—COO—CH₂—Si(OMe)₃, H₂C═CH—COO—CH₂—Si(OEt)₃, H₂C═C(CH₃)—COO—(CH₂)₃—Si(OEt)₃, H₂C═C(CH₃)—COO—(CH₂)₃—Si(OMe)₃, H₂C═C(CH₃)—COO—CH₂—Si(OMe)₃, H₂C═C(CH₃)—COO—CH₂—Si(OEt)₃, and HS—(CH₂)₃—Si(OMe)₃.

NH groups, which could impair the thermal stability and SO₂ absorption and regeneration characteristics or the addition crosslinking, can be converted by subsequent alkylation with alkyl halides or acetylation with carboxylic acids or carboxylic acid derivatives (e.g. acetyl chloride or isopropenyl acetate) to stable secondary amine functions or carboxamide functions.

The siloxanes of the general formula 1 may be used for the reversible bonding of sulfur dioxide (SO₂).

The siloxanes of the general formula 1 may be used not only as an absorber liquid, in a scrubber for example, but also crosslinked to form silicone vulcanizates, and for the purpose of enlarging the surface area, for example as filaments in the form of a non-woven material or as a coating on scaffolds or filler materials for the reversible bonding of sulfur dioxide. These are brought into contact with SO₂ or an SO₂-containing solid, liquid or gaseous substance mixture. For example, they can be incorporated in an exhaust flue. The SO₂ desorption is then effected as required by contact heating or indirectly, e.g. with a hot gas, steam or liquid stream or infrared or microwave irradiation. This can be carried out at the pressure of the surrounding atmosphere or at reduced or elevated pressure. The temperature is determined in this case on the one hand from the thermal decomposition behavior (100K rule with respect to the onset temperature in accordance with TRAS410) and on the other hand from the efficiency. At atmospheric pressure, it is typically in the range between 60° C. and 100° C. and can be reduced accordingly by lowering the working pressure.

When using the liquid siloxanes of the general formula 1 in a scrubber, the scrubbing liquid laden with SO₂ is preferably conveyed into a connected apparatus and heated therein, which enables a continuous uninterrupted operation. Also customary is a tandem mode of operation in which at least 2 scrubbers are used alternately for absorption and desorption.

When using the siloxanes and the siloxanes of the general formula 1 crosslinked to form silicon vulcanizates as solid absorbers, this offers a tandem mode of operation in which in each case an absorber section is used for the absorption, while the second is used for regeneration. Particularly at low absorption rates (in mol SO₂/h), processes can also be used in which internals consisting of the vulcanizate according to the invention, or coated therewith, are exchanged from time to time with fresh unladen internals. The SO₂ laden absorber can then be specifically regenerated in an appropriate device (e.g. an oven).

The SO₂ gas released can then be fed by appropriate coupling to corresponding plants specifically for utilization or disposal.

The invention also provides the vulcanizates that can be produced with the siloxanes of the general formula 1 according to the invention. The production thereof is effected either by moisture crosslinking via hydrolysis and condensation, if appropriate, of the Si-bonded amino, alkoxy or oximo groups present in the siloxanes of the general formula 1 with elimination of the corresponding amine, alcohol or oxime cleavage products, or by addition-crosslinking via unsaturated hydrocarbon radicals, preferably vinyl radicals, having SiH crosslinkers present in the siloxanes of the general formula 1 according to the invention in the presence of catalysts or radical initiators, or by radiation crosslinking via photocrosslinkable groups, particularly UV crosslinking via UV activatable groups, present in the siloxanes of the general formula 1. Examples of photocrosslinkable groups are acrylic groups, methacrylic groups, or thiol-ene combinations. In addition, reinforcing fillers such as hydrophobized silica, crosslinking retarders, rheology additives, plasticizers, adhesion promoters, color pigments, acid-base indicators and further auxiliaries may be mixed in.

The siloxanes of the general formula 1 may also be used as additives in crosslinkable standard silicone mixtures. Critical for the absorber capacity in this case is the density of functional groups of the general formula 2 (mol/kg). Both in the liquid siloxanes of the general formula 1 and in the vulcanizates produced therefrom it is in the range from 0.1-4.4 mol/kg, preferably in the range from 0.5-2 mol/kg, and most preferably between 0.5 and 1 mol/kg.

All symbols of the formulae above each have their own meaning independently of one another. In all formulae, the silicon atom is tetravalent. The sum of all constituents of the silicone mixture adds up to 100% by weight.

In the following examples, unless stated otherwise in each case, all amounts and percentages are based on weight, all pressures 0.10 MPa (abs.) and all temperatures 20° C.

### EXAMPLES

### Comparative Example (Non-Inventive)

### Preparation of N,N-bis-2-cyanoethyl-n-butylamine

Based on Denton, Travis, T. et al., Journal of Organic Chemistry, 72(13), 4997-5000, 2007, n-butylamine was reacted at 0-45° C. with an excess of acrylonitrile in methanol to give bis-2-cyanoethyl-n-butylamine and the target product was distilled under reduced pressure at 70° C./3 hPa (purity according to ¹H-NMR: 94.6%, 3.3% monoadduct, 1.9% 3-methoxypropionitrile.

### SO₂ Absorption

60 g (0.33 mol) of N,N-bis-2-cyanoethyl-n-butylamine were initially charged at 22° C. SO₂ gas, which had been generated from sodium sulfite and 25% sulfuric acid, was introduced by means of an immersion tube at standard pressure until no further weight increase was detectable. The temperature increased during the introduction to a maximum of 33.4° C. After 3 hours, the metered addition was terminated. The mass increase was 20 g, which corresponds to 0.312 mol of SO₂. The specific uptake was thus 0.945 mol of SO₂ per mole of N,N-bis-2-cyanoethyl-3-amino residue.

### Thermal Behavior of the Non-Inventive Absorber Laden with SO₂

The thermal behavior of a sample of this SO₂-saturated N,N-bis-2-cyanoethyl-n-butylamine was investigated between room temperature and 400° C. under a nitrogen atmosphere in a stainless steel crucible by means of DSC. At 164° C. a strong exotherm occurred. The amount of heat released was 1236 kJ/kg N,N-bis-2-cyanoethyl-n-butylamine. This corresponds to an amount of heat of 221 kJ/mol. At an estimated heat capacity Cₚ of 1.8 kJkg⁻¹K⁻¹, the amount of heat released would result in an adiabatic temperature increase of 687 K.

### Example 1

### Use of an Inventive Polysiloxane (Siloxane 1) as Liquid SO₂ Absorber

a) Preparation of a vinyl-terminated dimethylpolysiloxane having 3-aminopropyl groups:

625 g of a copolymer composed of vinyldimethylsiloxy and dimethylsiloxy units having a chain length of 29.5, 190 g of a silanol-terminated polydimethylsiloxane having about 50 siloxy units and 130 g of a hydrolyzate of 3-aminopropyldimethoxymethylsilane were mixed with 1.5 g of 20% methanolic potassium hydroxide solution and equilibrated at 130° C. and 40 hPa for three hours. After cooling to 110° C., 0.5 g of acetic acid was added. The mixture was stirred for 30 minutes and filtered through a pressure Nutsche filter. According to ²⁹Si— and ¹H-NMR, the filtrate had the following average composition: vinyl-SiMe₂O_{1/2}:Me₂SiO_{2/2}:MeSi(CH₂CH₂CH₂—NH₂)O_{2/2}=2:29.8:3.2.

b) Preparation of a vinyl-terminated dimethylpolysiloxane having N,N-bis-2-cyanoethyl-3-aminopropyl groups siloxane 1:

22 g of acrylonitrile (0.41 mol) were initially charged in 40 g of methanol. At 23° C., a solution of 100 g of aminopolysiloxane (0.116 mol of amine) in 100 g of methanol was metered in over 45 minutes. A temperature increase of 27° C. took place in this case. The mixture was stirred at 45° C. for a total of 34 hours before the low boilers were distilled off at 70° C. and 3 hPa. As residue, a clear colorless oil (siloxane 1) remained. According to ¹H-NMR, 90.3% of the primary amino groups in N,N-bis(2-cyanoethyl)amino groups and 4.1% in mono-2-cyanoethylamino groups had been converted. As a result, a functional density of 0.95 mmol/g N,N-bis(2-cyanoethyl)-3-aminopropyl and N-(2-cyanoethyl)-3-aminopropyl groups in siloxane 1 is obtained (at 100% conversion it would be 1 mmol/g).

c) Absorption and desorption of SO₂ on siloxane 1

50 g of siloxane 1 from example 1b (0.0475 mol of N,N-bis-2-cyanoethyl-3-aminopropyl groups) were initially charged at 22° C. SO₂ gas, which had been generated from sodium sulfite and 25% sulfuric acid, was introduced by means of an immersion tube at standard pressure until no further weight increase was detectable. The temperature increased during the introduction to a maximum of 33.4° C. After 3 hours, the metered addition was terminated. The mass increase was 4.5 g (=9% by mass), which corresponds to 0.07 mol of SO₂. The specific uptake was thus 1.47 mol of SO₂ per mole of N,N-bis-2-cyanoethyl-3-aminopropyl and N-(2-cyanoethyl)-3-aminopropyl groups.

The thermal behavior of a sample of this SO₂-saturated product was investigated between room temperature and 400° C. under a nitrogen atmosphere in a stainless steel crucible by means of DSC. At 205° C. a strong exotherm occurred. The amount of heat released was 225 kJ/kg. Normalized to the amine functions present in the siloxane (0.95 mmol/g), this corresponds to an amount of heat of 237 kJ/mol N,N-bis-2-cyanoethyl-3-aminopropyl groups. At an estimated heat capacity Cₚ of 1.8 kJkg⁻¹K⁻¹, the amount of heat released would result in an adiabatic temperature increase of 125 K.

47.5 g of the siloxane saturated with SO₂ were heated to 100° C. over 15 minutes in order to drive off the SO₂. Here, a gentle nitrogen stream of 5 l/h was passed over. After one hour, the weight loss was 3.9 g, which corresponds virtually completely to the amount of bound SO₂.

The residue was again saturated with SO₂ at 24-28° C. The mass increase was again 9% by mass. The subsequent desorption at 100° C. was again likewise effected completely.

### Example 2: Use of an Inventive Polysiloxane as Solid SO₂ Absorber

a) Post-treatment of siloxane 1 with isopropenyl acetate (MF23) (preparation of siloxane 2)

A mixture of 64 g of siloxane 1 and 32 g of isopropenyl acetate was heated to reflux for three hours after which all volatile constituents were distilled off up to 85° C./3 hPa. A clear reddish liquid (siloxane 2) was isolated. Via ¹H-NMR spectroscopy, the complete conversion of the free NH groups to acetamide residues could be verified.

b) Preparation of an elastic silicone molding from siloxane 2 10.00 g of siloxane 2 (6 mmol of vinyl) were mixed with 1.95 g of an H-crosslinker of average formula Me₃Si—(OSiMe₂)₆₄—(OSiHMe)₃₁—OSiMe₃ (6 mmol), 2.00 g of HDK SKS 300 (hydrophobized highly dispersed silica from WACKER CHEMIE AG) three times each for 4 minutes using a SpeedMixer™, after which 0.22 g of a Pt catalyst (Karstedt catalyst, 1,3-divinyl-1,1,3,3-tetramethyldisiloxane complex dissolved in toluene, 0.32% Pt) were mixed in with the SpeedMixer™ (50 ppm Pt). The mixture was cured in an aluminum bowl at 200° C. for 20 minutes in a drying cabinet to form an elastic, cylindrical molding. Mathematically, a functional density of 0.67 mmol/g N,N-bis-(2-cyanoethyl)-3-aminopropyl or N-acetamido-N-(2-cyanoethyl)-3-aminopropyl groups in the vulcanizate is obtained.

c) Absorption and desorption of SO₂ on a silicone rubber body The silicone molding produced from siloxane 2 was sliced into cubes of about 5 mm edge length. 11.5 g of these silicone rubber pieces were placed in a glass tube and exposed at 23° C. to an SO₂ atmosphere at ambient pressure (995 hPa) for 2 hours. The weight increase was 0.556 g, which corresponds to 8.7 mmol of SO₂. The specific uptake was therefore at 1.11 mol of SO₂/mol amine. Heating the molding to 100° C. completely released the bound SO₂ again.

1.-9. (canceled)

10. A siloxane comprising units of the formula 1
RₙSiO_{(4-n)/2} (1),
wherein
R is a hydrocarbon radical having 1-16 carbon atoms, optionally substituted by halogen, alkoxy, acyloxy, oximo, acryloxy or methacryloxy radicals, OH radicals, C₁-C₄-alkoxy radicals, oximo radicals of the formula O═NR⁵R⁶, amino radicals of the formula —NR⁷R⁸ or a radical of the formula 2
-A-NR¹₂₋ₘ(CR²₂—CR³₂—CN)ₘ (2),
R¹ is hydrogen or hydrocarbon radical having 1-6 carbon atoms or —C(O)—R′,
A is a bifunctional hydrocarbon radical having 1-18 carbon atoms, optionally interrupted by one or more non-adjacent heteroatoms selected from O, S and NR⁴,
R⁴ is hydrogen or a hydrocarbon radical having 1-6 carbon atoms or a radical CR^{2′}₂—CR^{3′}₂—CN or a radical —C(O)—R″,
R′, R², R³, R^{2′}, R^{3′} and R″ are hydrogen or hydrocarbon radicals having 1-6 carbon atoms,
R⁵, R⁶, R⁷ and R⁸ are methyl, ethyl, n-propyl or isopropyl radicals,
m has the values 0, 1 or 2 and
n has the average value 2.00-2.66,
with the proviso that
at least 50 mol % of all R radicals are alkyl radicals,
at least 0.5 mol % of all R radicals are a radical of the general formula 2 in which m has the values 1 or 2,
in at least 5 mol % of all radicals of the formula 2, m has the value 2,
at most 10 mol % of all R¹ radicals are a hydrogen radicals and
at least 3 and at most 2000 Si atoms are present per molecule.

11. The siloxane of claim 10, in which the hydrocarbon radicals R comprise 1-6 carbon atoms.

12. The siloxane of claim 10, in which at least one radical A is selected from the group consisting of:
CH₂—CH₂—CH₂—, —CH₂—CH₂—CH₂—N(—CH₂—CH₂—CN)—CH₂—CH₂—, —CH₂—CH₂—CH₂—N(—COCH₃)—CH₂—CH₂— and —CH₂—CH₂—CH₂—NH—CH₂—CH₂—.

13. The siloxane of claim 10, in which radicals A are selected from the group consisting of:
CH₂—CH₂—CH₂—, —CH₂—CH₂—CH₂—N(—CH₂—CH₂—CN)—CH₂—CH₂—, —CH₂—CH₂—CH₂—N(—COCH₃)—CH₂—CH₂— and —CH₂—CH₂—CH₂—NH—CH₂—CH₂—.

14. The siloxane of claim 10, in which at least two unsaturated hydrocarbon radicals are present per molecule of siloxane of the formula 1.

15. The siloxane of claim 11, in which at least two unsaturated hydrocarbon radicals are present per molecule of siloxane of the formula 1.

16. The siloxane of claim 12, in which at least two unsaturated hydrocarbon radicals are present per molecule of siloxane of the formula 1.

17. The siloxane of claim 13, in which at least two unsaturated hydrocarbon radicals are present per molecule of siloxane of the formula 1.

18. The siloxane of claim 10, in which m has the value 2 in at least 20 mol % of all radicals of the formula 2.

19. A process for crosslinking a siloxane of the formula 1 of claim 10, to give vulcanizates, by moisture crosslinking via hydrolysis and condensation of the Si-bonded amino, alkoxy or oximo groups present in the siloxanes of the formula 1, or by addition-crosslinking via unsaturated hydrocarbon radicals present in the siloxanes of the formula 1 with SiH crosslinkers, or by radiation crosslinking via photocrosslinkable groups present in the siloxanes of the formula 1.

20. A vulcanizate of at least one siloxane of the formula 1, prepared by the process of claim 19.

21. A process for the reversible bonding of sulfur dioxide, comprising exposing to siloxane of the formula 1 of claim 10, or to a vulcanizate thereof, thereby absorbing SO₂, and heating the siloxane or vulcanizate thereof, liberating SO₂.
